(19) United States
(12) Patent Application Publication
(10) Pub. No.: US 2026/0070514 A1
(43) Pub. Date: Mar. 12, 2026

(54) WIPING SYSTEM FOR A VEHICLE AND VEHICLE

(71) Applicant: Robert Bosch GmbH, Stuttgart (DE)

(72) Inventors: Manuel Hans Reith, Lauf (DE); Gerald Maier, Ottersweier-Unzhurst (DE); Robert-Jan van de Rovaart, Ottersweier (DE)

(21) Appl. No.: 19/320,626

(22) Filed: Sep. 5, 2025

(30) Foreign Application Priority Data
Sep. 10, 2024 (DE) 10 2024 208 600.2

(51) Int. Cl. B60S 1/08

(52) U.S. Cl. CPC B60S 1/0818

(57) ABSTRACT

The present invention relates to a wiping system for a vehicle and such a vehicle, wherein the wiping system comprises: at least one wiper arm having a connected wiper blade, a wiper motor and a control unit, wherein the wiping system is configured to be mounted in the area of a windshield of a vehicle, to cause, based on a movement of the wiper arm and the wiper blade connected thereto, cleaning of the windshield within a first predefined wiping area, and wherein the control unit is configured to determine an activation requirement to activate a high efficiency wiping mode of the wiping system and, in the event of such determined activation requirement, to adjust control of the wiper motor, such that the wiper arm moves back and forth over the windshield at a wiping frequency of at least wiping operations per minute and/or the wiper arm moves back and forth exclusively within a second wiping area of the windshield, which is a sub-area of the first wiping area.

### BACKGROUND

The present invention relates to a wiping system for a vehicle and a vehicle having such a wiping system.

From the prior art, wiping systems for vehicle windows are known, which are equipped with electronically controlled wiping drives (so-called reversing motors) or with standard wiping drives (so-called 360° rotary motors) to move one or more wiper arms of the wiping systems over a corresponding vehicle window, in particular a windshield.

It is also known that controlling the wiping drives to start, stop, or adjust the wiping operations to current conditions is accomplished via actuation of a steering rod switch of the vehicles by a driver and/or by a rain sensor.

### SUMMARY

According to a first aspect of the present invention, a wiping system for a vehicle is proposed comprising at least one wiper arm a connected wiper blade, a wiper motor and a control unit.

The wiping system is configured to be mounted in the area of a windshield of a vehicle on order to cause cleaning of the windshield within a first predefined wiping area based on movement of the wiper arm and the wiper blade connected thereto.

Advantageously, the wiper blade has a rubber lip connected to the wiper blade that is in contact with the windshield such that the wiping system is configured to clean the windshield of the vehicle using the rubber lip. The term “cleaning” is generally meant to mean any removal of debris from the windshield, which in addition to removing dirt, also includes removing precipitation, in particular rain, snow, hail, etc.

The control unit is configured as, for example, an ASIC, a microcontroller, a processor, or a computational unit different from this. It is also possible for the control unit to be configured as a separate component or as a component that is integrated into an existing control unit of the vehicle.

The control unit is configured to determine an activation requirement to activate a high efficiency wiping mode of the wiping system and, in the event of a determined activation requirement, adjust control of the wiper motor, such that the wiper arm moves back and forth over the windshield at a wiping frequency of at least 61 wiping operations per minute and/or such that the wiper arm moves back and forth exclusively within a second wiping area of the windshield, which is a sub-area of the first wiping area.

A single wiping operation is intended herein to be a complete wiping movement of the wiper arm starting from a start position of the wiper arm to an end position of the wiper arm and back to the start position. In other words, the wiper arm moves back and forth 61 times per minute over the windshield during 61 wiping operations.

In the case, in which the wiping area is restricted from the first wiping area to the smaller second wiping area, for example, the start position and/or the end position for the wiper arm is adjusted so that they are closer together, such that cleaning performance of the wiping system can be increased due to the lesser travel path of the wiper arm within the second wiping area, without adjusting a wiping frequency of the wiper motor, wherein the latter, of course, is additionally possible.

The wiping system according to the invention offers the advantage, among other things, that even in a case where there is above-average impact to the windshield due to water (for example rain water, splashed water, etc.) and/or from other precipitation and/or dirt, particularly fast and/or particularly effective cleaning of the windshield can be ensured, whereby the view of occupants, in particular, a driver of the vehicle of the road ahead can be improved and an accident risk can be minimized accordingly.

The dependent claims disclose preferred further developments of the invention.

The wiper motor is particularly advantageously a brushless DC motor (also known as an EC motor), which allows for particularly fast wiping operations and a particularly flexible control of the wiper motor. Alternatively or additionally, the wiper motor is advantageously configured to provide a wiping frequency of at least 61, preferably at least 63, and more preferably at least 65 wiping operations per minute. In this way, a particularly high cleaning performance can be achieved by the wiping system according to the invention.

Preferably, the wiping system according to the present invention is configured to determine the activation requirement of the high efficiency wiping mode based on receipt of an activation signal provided from outside the wiping system. For example, the activation signal is received from a control unit of the vehicle and/or via a wireless communication device of the vehicle from outside the vehicle. In the latter case, the activation signal may be provided, for example, by further traffic participants and/or further stationary and/or mobile facilities such as cloud servers, etc. Alternatively or additionally, the wiping system is configured to determine the activation requirement based on information about current conditions, wherein the conditions particularly include a current amount of precipitation (which may be sensed, e.g., by means of a rain sensor and/or a camera and/or other sensors of the vehicle) and/or a current speed of the vehicle and/or a current traffic situation and/or a height and/or a type of current traffic and/or a current geoposition of the vehicle. It is to be understood that further conditions not explicitly mentioned herein may also be considered when determining the activation requirement. For example, by evaluating the current traffic and/or speed of the vehicle, a criticality of a current driving situation with a given amount of precipitation can be determined, for example, so that it may be advantageous, even with an average amount of precipitation, to determine the activation requirement of the high efficiency wiping mode, to ensure a clear view for a driver of the vehicle in critical environmental conditions by quickly and efficiently cleaning the windshield according to the invention.

In an advantageous embodiment of the present invention, the wiping system is configured to determine a current temperature of the wiper motor and if the current temperature of the wiper motor exceeds a predefined threshold temperature, to inhibit activation of the high efficiency wiping mode (e.g., to prevent damage to the engine due to a resulting too high temperature) and/or to output an alert signal (e.g., to a driver of the vehicle) and/or a speed reduction signal of the vehicle (e.g., to a system for automated travel operation and/or to a driver assistance system, etc.) and/or a signal for preparing an emergency braking system and/or reducing the temperature of the wiper motor prior to activating the high efficiency wiping mode. This is done, for example, by reducing a wiping frequency prior to activating the high efficiency wiping mode and/or by actively cooling the engine using a cooling system and/or by performing a speed reduction of the vehicle requiring a lower wiping frequency of the wiper arm, etc.

In a further advantageous embodiment of the present invention, the wiping system is configured to predict a need for activation of the high efficiency wiping mode based on information about current conditions and, in the case of a predicted need for activation, to prepare the wiping system for activation of the high efficiency wiping mode. For example, the prediction may be based on weather information that may be received via a weather service, among other things, and that informs about a type and/or an amount of precipitation in an area that the vehicle will drive through in the future based on a current route. Alternatively or additionally, for example, it is possible to receive weather information and/or other information that may relate to the vehicle along its route from other vehicles via Car2Car communication, etc.

The wiping system according to the invention is particularly advantageously configured to prepare the wiping system for activating the high efficiency wiping mode by moving the wiper arm to a predefined cleaning position (e.g., a position from which a particularly rapid start of cleaning can be achieved) and/or moving a potentially further existing wiper arm (e.g., a wiper arm on a passenger side of the windshield) to a predefined parking position. The latter may be advantageous in order to prevent potential restriction of movement of the wiper arm on the driver’s side of the windshield, which may result, for example, from a required coordination between the two wiper arms. In this way, a particularly flexible control for the wiper arm on the driver’s side can be achieved, which can result in a particularly fast and/or efficient cleaning of the driver’s side of the windshield.

In a further advantageous embodiment of the present invention, the second wiping area is a predefined second wiping area, which is defined, for example, as a function of a typical field of view of a driver of the vehicle. Alternatively or additionally, the control unit is configured to determine the second wiping area in accordance with a current field of view of a respective driver of the vehicle.

The control unit is particularly advantageously configured to determine the field of view of the driver based on information about an eye position and/or a direction of view of the driver and/or a size of the driver. This information may be determined, for example, by means of an interior camera and/or an identification of a particular driver based on a key identification number and/or an identification via a mobile terminal, etc., coupled to the vehicle. Moreover, it is conceivable that the control unit is configured to determine the driver’s field of view based on information concerning an adjustment of a driver’s seat, which may be provided to the control unit via a seat module of the vehicle, among other things, and based on which a seat position and/or a position of the driver may be estimated by the control unit.

Preferably, the wiper arm of the wiping system is a first wiper arm (in particular, a wiper arm located on the driver’s side of the windshield), while the wiping system comprises a second wiper arm (in particular, a wiper arm located on the passenger side of the windshield). In this case, the control unit is configured to also adjust control of the second wiper arm in the event of activation of the high efficiency wiping mode. This may be done, for example, as described above, in that the second wiper arm is conveyed to a predefined parking position and/or in that the second wiper arm is controlled such that liquids removed from the first and/or second wiping area by the first wiper arm, etc. are removed from the windshield as quickly and effectively as possible by the assistance of the second wiper arm.

According to a second aspect of the present invention, a vehicle is proposed comprising a wiping system according to the first aspect of the invention, a windshield and an on-board electrical system. For example, the vehicle is configured as a passenger car, truck, van, bus, rail vehicle, etc. The wiping system is located in the area of the windshield of the vehicle for cleaning the windshield. In addition, the on-board power system is configured to provide information required to activate the high efficiency wiping mode of the wiping system to the control unit. For this purpose, the control unit is informationally connected to the on-board power system so that it can receive the required information from other control devices of the vehicle. The features, feature combinations, and the resulting advantages correspond to those explained in connection with the first aspect of the invention specified in the introductory section are clear enough that reference will be made to the explanations hereinabove in order to avoid repetitions.

### BRIEF DESCRIPTION OF THE DRAWINGS

An exemplary embodiment of the invention is described in detail hereinafter with reference to the accompanying drawings. The drawings show:

FIG. 1 a schematic view of an exemplary embodiment of a vehicle according to the present invention in conjunction with a wiping system according to the present invention.

### DETAILED DESCRIPTION

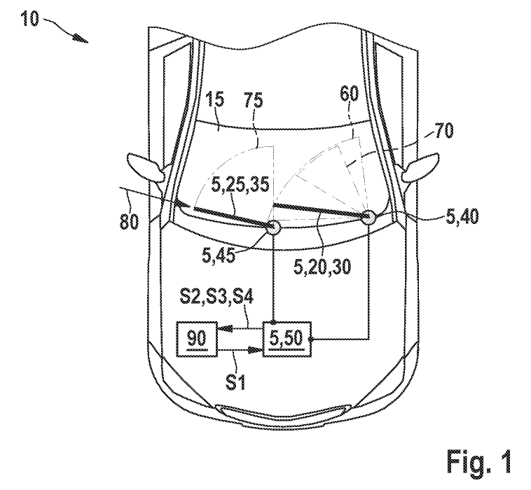

FIG. 1 shows a schematic view of an exemplary embodiment of a vehicle 10 according to the invention in conjunction with a wiping system 5 according to the invention.

The vehicle 10 is configured herein as a passenger car, as an example, which has a windshield 15 in the vicinity of which the wiping system 5 according to the invention is mounted.

The wiping system 5 comprises a first wiper arm 20 having a connected wiper blade 30 and a second wiper arm 25 having a connected second wiper blade 35, wherein the first wiper arm 20 is provided here for cleaning an area of a driver side and the second wiper arm 25 for cleaning an area of a passenger side of the windshield 15.

The wiping system 5 further comprises a first wiper motor 40 configured as a brushless DC motor, which is configured to move the first wiper arm 20 over the windshield 15 and a second wiper motor 45 configured as a brushless DC motor, which is configured to move the second wiper arm 25 over the windshield 15.

The first wiper motor 40 and the second wiper motor 45 are each electrically connected to a control unit 50 configured as an ASIC.

Based on the configuration described above, the wiping system 5 is configured to cause cleaning of the windshield 15 by means of a movement of the wiper arms 20, 25 and the respective connected wiper blades 30, 35, wherein the first wiper arm 20 is provided for cleaning within a first predefined wiping area 60 and the second wiper arm 25 for cleaning within a third predefined wiping area 75.

The control unit 50 is configured to determine an activation requirement to activate a high efficiency wiping mode of the wiping system 5 based on an activation signal S1, which is provided by a control unit (not shown) of the vehicle 10 via an on-board power system 90 of the vehicle 10 if a precipitation amount acting on the windshield 15 exceeds a predefined threshold.

In the case where the control unit 50 determines an activation requirement, it is configured to respond by adjusting control of the first wiper motor 40 such that the wiper arm 20 moves back and forth with a wiping frequency of 65 wiping operations per minute over the windshield 15 and/or the wiper arm 20 moves back and forth exclusively within a second wiping area 70 of the windshield 15, which is part of the first wiping area 60.

For this purpose, the control unit 50 is configured to determine the second wiping area 25 in accordance with a field of view of a driver of the vehicle 10 by informationally connecting the control unit 50 via the on-board power system 90 to an interior camera (not shown) on the basis of which the control unit 50 is configured to determine a position and a direction of view of the driver’s eyes with respect to the windshield 15. Thus, the control unit 50 is further configured to define the second wiping area 70 to be set as small as possible while substantially not restricting a driver’s required view of the vehicle’s environment.

Moreover, the control unit 50 is configured to control the second wiper motor 45 to move the second wiper arm 25 to a predefined parking position 80 during activation of the high efficiency wiping mode. In this way, it is advantageously ensured that there can be no collision between the two wiping arms 20, 25 during activation of the high efficiency wiping mode.

The wiping system 5 is further configured to determine a current temperature of the first wiper motor 40 based on a temperature sensor (not shown) and, if the current temperature of the first wiper motor 40 exceeds a predefined temperature threshold, to inhibit activation of the high efficiency wiping mode to prevent damage to the first wiper motor 40 due to too high a temperature.

In the case where the high efficiency wiping mode cannot be activated due to too high a temperature of the first wiper motor 40, the control unit 50 is configured to issue an alert signal S2 to the on-board power system 90, which indicates the fact that it is not possible to activate the high efficiency wiping mode despite an existing activation requirement.

An on-board computer system (not shown) of the vehicle 10 is configured to receive the alert signal S1 and, in response to receiving the alert signal S1, to issue an alert in a display (not shown) of the vehicle 10 and an alert tone via an audio system (not shown) of the vehicle 10 to inform a driver of the vehicle 10 that activation is not possible.

In this case, the control unit 50 is also configured to output a signal S3 for a speed reduction of the vehicle 10 and a signal S4 for preparing an emergency braking system to the on-board power system 90.

It should be noted that the signals S2, S2, S3 can each be separate signals or at least partially the same signal.

In response to receipt of signals S3 and S4, respective (not shown) driver assistance systems of the vehicle 10 are configured to automatically reduce a current speed of the vehicle 10 and prepare for potential emergency braking by the vehicle 10 in the event the driver of the vehicle is not responding, or not responding in a timely manner, to the visual output of the alert and/or the audible output of the alert tone, in order to reduce the danger of having an accident hazard due to limited visibility through the windshield 15 during a driving situation with a particularly high impact of precipitation, etc. on the windshield 15.

1. A wiping system (5) for a vehicle (10) comprising:
a wiper arm (20) having a connected wiper blade (30), a wiper motor (40), and
a control unit (50),
wherein
the wiping system (5) is configured to be mounted in an area of a windshield (15) of a vehicle (10) in order to cause cleaning of the windshield (15) within a first predefined wiping area (60) based on movement of the wiper arm (20) and the wiper blade (30) connected thereto, and
the control unit (50) is configured
to determine an activation requirement to activate a high efficiency wiping mode of the wiping system (5), and
in the event of a determined activation requirement, to adjust control of the wiper motor (40), such that the wiper arm (20) moves back and forth over the windshield (15) with a wiping frequency of at least 61 wiping operations per minute and/or the wiper arm (20) is exclusively moved back and forth within a second wiping area (70) of the windshield (15), which is a sub-area of the first predefined wiping area (60).

2. The wiping system (5) according to claim 1, wherein the wiper motor (40)
is configured as a brushless DC motor, and/or
is configured to provide a wiping frequency of at least 61 wiping operations per minute.

3. The wiping system (5) according to claim 1, wherein the wiping system (5) is configured to determine the activation requirement of the high efficiency wiping mode based on receiving
an activation signal (S1) provided from outside the wiping system (5), and/or
determine information about current conditions, which include
a current precipitation amount, and/or - a current speed of the vehicle (10), and/or
a current traffic situation, and/or
a height and/or type of current traffic, and/or
a current geoposition of the vehicle (10).

4. The wiping system (5) according to claim 1, wherein the wiping system (5) is configured to
determine a current temperature of the wiper motor (40), and
if the current temperature of the wiper motor (40) exceeds a predefined temperature threshold,
inhibit activation of the high efficiency wiping mode, and/or
output an alert signal (S2), and/or
output a signal (S3) for a speed reduction of the vehicle (10), and/or
output a signal (S4) for preparing an emergency braking system, and/or
reduce the temperature of the wiper motor (40) prior to activating the high efficiency wiping mode.

5. The wiping system (5) according to claim 1, wherein the wiping system (5) is configured to
predict an activation requirement of the high efficiency wiping mode based on information about current conditions, and
in the case of a predicted activation requirement, prepare the wiping system (5) for activation of the high efficiency wiping mode.

6. The wiping system (5) according to claim 5, wherein the wiping system (5) is configured to prepare the wiping system (5) for activating the high efficiency wiping mode by
the wiper arm (20) being moved to a predefined cleaning position, and/or
a potentially further existing wiper arm (25) being moved to a predefined parking position (80).

7. The wiping system (5) according to claim 1, wherein
the second wiping area (25) is a predefined second wiping area (25), and/or
the control unit (50) is configured to determine the second wiping area (25) in accordance with a field of view of a driver of the vehicle (10).

8. The wiping system (5) according to claim 7, wherein the control unit (50) is configured to determine the driver’s field of view based on information about an eye position and/or a driver’s direction of view and/or a driver’s size and/or adjustment of a driver’s seat.

9. The wiping system (5) according to claim 1, wherein
the wiper arm is a first wiper arm (20), - the wiping system (5) comprises a second wiper arm (25), and
the control unit (50) is configured to adjust control of the second wiper arm (25) in the event of activation of the high efficiency wiping mode.

10. A vehicle (10) comprising:
a wiping system (5) according to,
a windshield (15), and
an on-board power system (90), wherein
the wiping system (5) is arranged in the area of the windshield (15) for cleaning the windshield (15), and
the on-board power system (90) is configured to provide required information for activating the high efficiency wiping mode of the wiping system (5).
